(19) United States
(12) Patent Application Publication
(10) Pub. No.: US 2010/0014004 A1
(43) Pub. Date: Jan. 21, 2010

(54) TELEVISION AND METHOD WITH IMPROVED VOLUME CONTROL

(75) Inventor: LUNG DAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/500,617

(22) Filed: Jul. 10, 2009

(30) Foreign Application Priority Data
Jul. 15, 2008 (CN) 200810302748.1

(51) Int. Cl. H04N 5/44

(52) U.S. Cl. 348/734; 348/E05.096

(57) ABSTRACT

A television includes a memory, a processor, and a volume adjusting application stored in the memory. The volume adjusting application is configured for execution by the processor to provide at least two-step volume control of audio signals converted from television programs. In a first step, the volume of the audio signals is quickly adjusted from a normal level to a background level by operating a mute key provided on a remote control. In a second step, the volume of the audio signals is completely muted by further operating the mute key provided on the remote control. Therefore, the volume of the audio signals can be adjusted without having to repeatedly hitting conventional volume control buttons provided on the remote control.

### BACKGROUND

1. Technical Field

The present disclosure relates to televisions (TVs), and more particularly to a television in association with a remote volume control.

2. Description of Related Art

The volume of a television may be adjusted via volume keys. In addition, the volume may be completely muted via a mute key. However, in situations where the user may want the volume to be decreased (or increased) to a certain level, the user must repeatedly press the volume keys and at the same time observe the volume level on the television screen, this is an inconvenience.

Therefore, it is desired to overcome the described shortcomings and deficiencies.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of a television in association with a remote control in accordance with an exemplary embodiment.

FIG. 2 is a top view of the remote control of FIG. 1 in accordance with an exemplary embodiment.

FIG. 3 is a block diagram of the television of FIG. 1 in accordance with an exemplary embodiment.

FIG. 4 is a flowchart illustrating a method for adjusting a volume of audio signals in accordance with an exemplary embodiment.

FIG. 5a is a first display interface displayed by the television of FIG. 1.

FIG. 5b is a second display interface displayed by the television of FIG. 1.

FIG. 5c is a third display interface displayed by the television of FIG. 1.

### DETAILED DESCRIPTION

In general, the present disclosure provides a novel and non-obvious way of adjusting the volume of audio signals outputted by a television. Particularly, the present disclosure provides at least two-step volume control of audio signals by operating a mute key provided on a remote control. In a first step, the volume of the audio signals is quickly adjusted from a normal level to a background level by operating the mute key provided on the remote control. In this case, when the volume of the audio signals is adjusted to the background level, the users can converse in a relatively quiet environment. In a second step, the volume of the audio signals is completely muted by further operating the mute key provided on the remote control. In this case, when the volume of the audio signals is muted, the uses may make a phone call in a quiet environment. Therefore, the volume of the audio signals can be more easily adjusted without having to repeatedly hitting conventional volume control keys provided on the remote control.

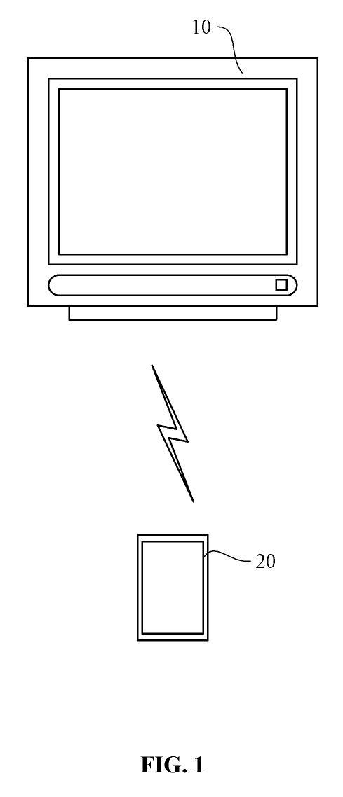

Referring to FIG. 1, a schematic diagram of a television 10 in association with a remote control 20 in accordance with an exemplary embodiment is illustrated. The television 10 may be controlled by the remote control 20 to adjust/change various settings, such as television channel and/or volume.

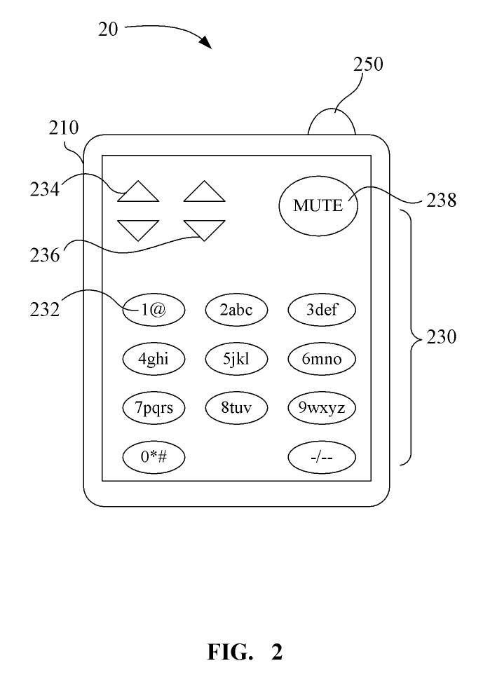

Referring to FIG. 2, a top view of the remote control 20 of FIG. 1 in accordance with an exemplary embodiment is illustrated. The remote control 20 may include a housing 210, a keypad 230, and a transmitter 250.

The housing 210 may include a structure to contain components of the remote control 20. For example, the housing 210 may be formed from plastic or metal and may support, the keypad 230, and the transmitter 250.

The keypad 230 may include any component capable of providing inputs to the remote control 20. The keypad 230 may include a plurality of input keys 232. The plurality of input keys 232 are appropriately arranged like a telephone keypad. Each of the plurality of keys 232 is associated with a numeric number and multiple characters/letters. The keypad 230 may also include channel keys 234 and volume keys 236. The channel keys 234 are configured for selecting channels of the television 10. The volume keys 236 are configured for adjusting the volume of the television 10. The keypad 230 may further include a mute key 238. The mute key 238 may be appropriately arranged to provide a two-step volume control of audio signals outputted by the television 10, which will be described hereinafter.

The transmitter 250 may include any component capable of issuing a command for transmitting operation to the television 10. In one implementation, the command is transmitted to the television 10 via infrared.

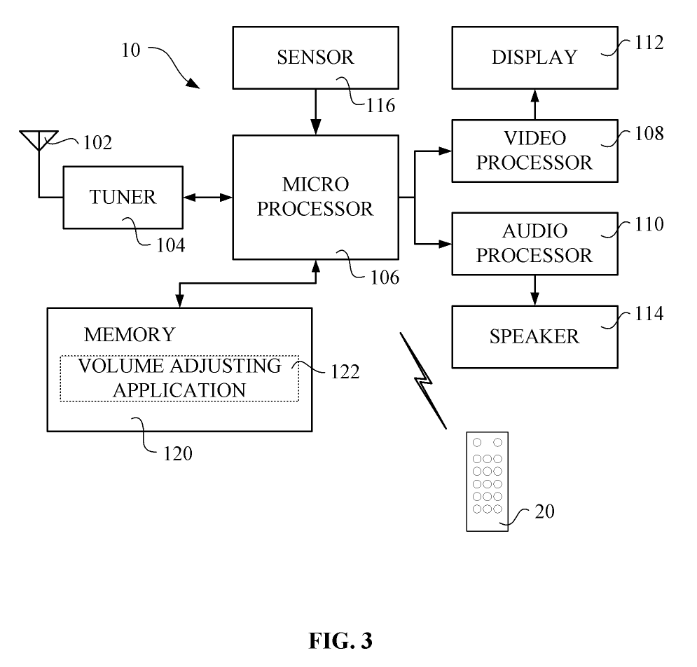

Referring to FIG. 3, a block diagram of the television 10 of in FIG. 1 is illustrated. As illustrated, the television 10 may include an antenna 102, a tuner 104, a microprocessor 106, a video processor 108, an audio processor 110, a display 112, a speaker 114, and a memory 120.

The antenna 102 may include any component capable of receiving digital broadcasting signals. The digital broadcasting signals are transmitted in the form of electromagnetic carrier waves over the air at predetermined frequencies. The antenna 102 generates radio frequency (RF) signals based on the digital broadcasting signals.

The tuner 104 is coupled between the antenna 102 and the microprocessor 106. The tuner 104 may be a digital tuner for receiving channel selection signals from the microprocessor 106 in response to input commands from the remote control 20. The tuner 104 further converts selected RF signals into intermediate frequency (IF) signals, and demodulates the IF signals to generate digital baseband signals. The digital baseband signals generally include video data, audio data, and extended service data such as closed caption data.

The microprocessor 106 may include any logic that access instructions from the memory 260, and interprets and executes instructions to control the overall operation of the television 10. As used herein, the term “logic” may include hardware, software, and/or a combination of hardware and software. The microprocessor 106 may include, for example, a general-purpose processor, a microprocessor, a data processor, a co-processor, a network processor, an application specific integrated circuit (ASIC), a controller, a programmable logic device, a chipset, a field programmable gate array (FPGA), etc. The microprocessor 106 receives the digital baseband signals from the tuner 104, and processes the digital baseband signals to generate encoded video data and encoded audio data. The encoded video data may be encoded and/or compressed according to the MPEG-2 video standard. The encoded audio data may be encoded and/or compressed according to Dolby Digital® audio standard.

The video processor 108 decompresses and/or decodes the encoded video data from the microprocessor 106 and provides decoded video signals of a video portion of a program channel. The video portion of the television program is displayed by the display 112.

The audio processor 110 decompresses and/or decodes the encoded audio data from the microprocessor 106 and provides decoded audio signals representative an audio portion of a television program. The audio portion of the television program is output from the speaker 114.

The memory 120 may include any type of storage component that stores data and instructions related to the operation and use of the remote control 20. For example, the memory 120 may include a memory component, such as a random access memory (RAM), a dynamic random access memory (DRAM), a static random access memory (SRAM), a synchronous dynamic random access memory (SRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory.

The memory 120 further stores a volume adjusting application 122. The volume adjusting application 122 contains software instructions. The software instructions may be read out of the memory 120 and may be interpreted and executed by the microprocessor 106 to perform various functions which will be described hereinafter.

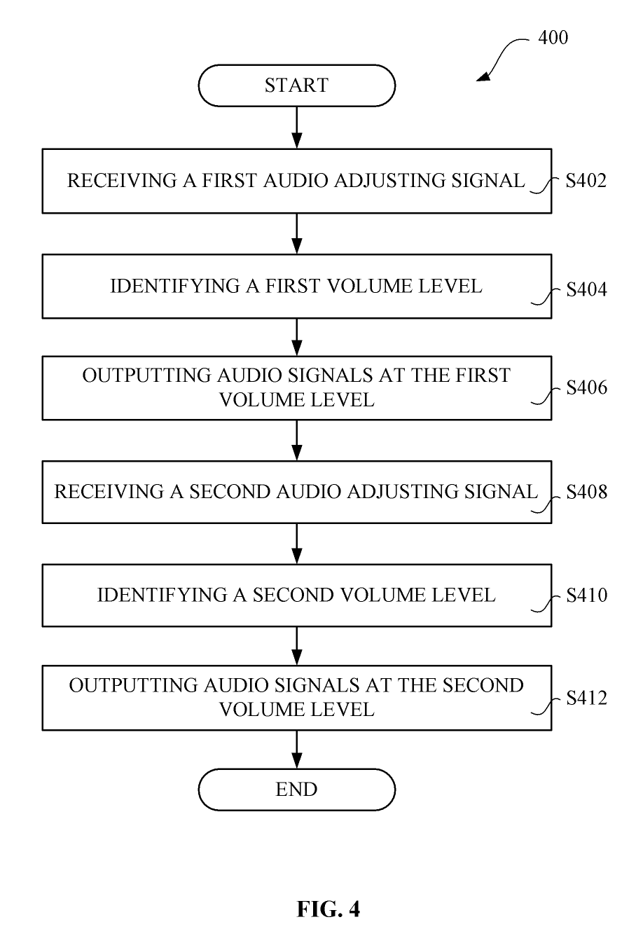

Referring to FIG. 4, a flowchart illustrating a method 400 for volume control includes following steps.

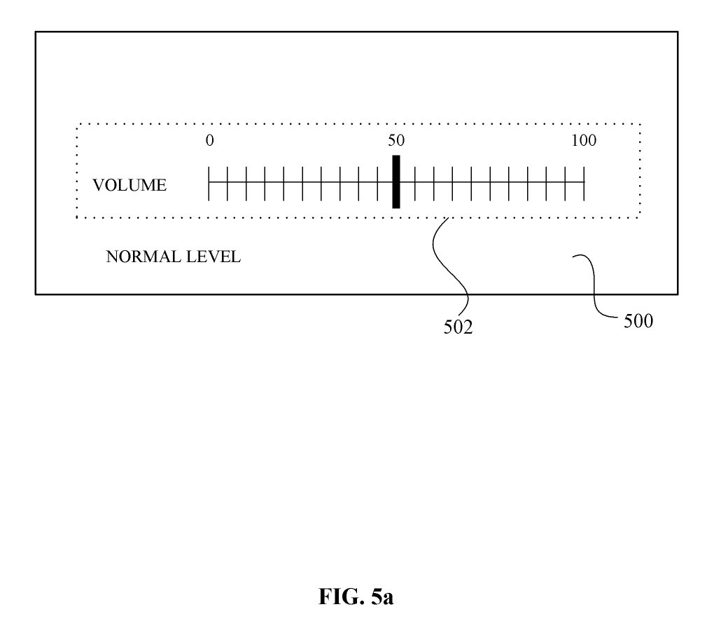

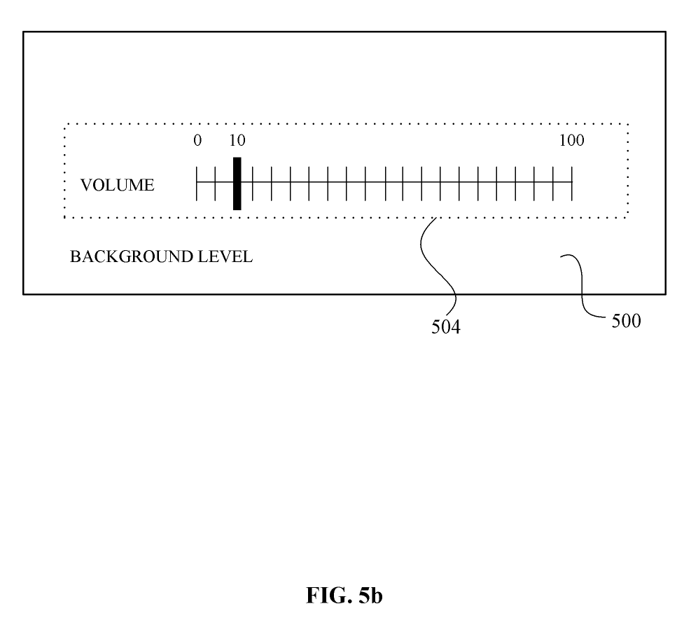

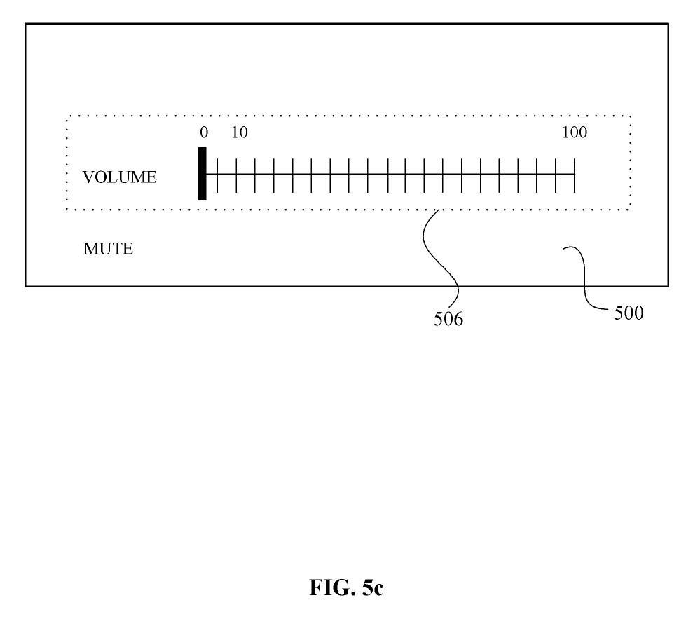

At step S402, the television 10 receives a first volume control signal. In one implementation, the first volume control signal is inputted by actuating the mute key 238 provided on the remote control 20. The first volume control signal is intended to quickly adjust the sound at a normal volume to a background volume. As used herein, the “normal volume level” refers to sound outputted from the television 10 that can be clearly heard. For example, referring to FIG. 5a, the television 10 may display an on-screen display (OSD) 500. The OSD 500 includes a first volume field 502 with the volume level identified as “50”. The “background volume level” refers to the audio signals outputted from the television 10 that may not be clearly heard by the users. As an example, referring to FIG. 5b, the OSD 500 includes a second volume field 504 with the volume level identified as “10”. When the sound is at the second volume field value, people can converse in a relatively quiet environment, i.e., the sound from the TV does not affect conversations.

At step S404, the television 10 identifies a first volume level or a background volume level corresponding to the first volume control signal. In one implementation, in addition to the volume adjusting application 122, the memory 120 of the television 10 may further store a table I shown as below. The table specifies a relationship between different volume control signals and different volume levels correspondingly. For example, when the first volume control signal is received, the first volume level “10” is read.

TABLE I
Volume adjusting table

| Volume control signal | Volume level |
|---|---|
| First volume control signal | 10 |
| Second volume control signal | 0 |
| Third volume control signal | 50 |

At step S406, the television 10 outputs audio signals at the first volume level or the background volume level.

At step S408, the television 10 receives a second volume control signal. In one implementation, the second volume control signal is also inputted by actuating the mute key 238 provided on the remote control 20. The second volume control signal is to completely mute the audio signals.

At step S410, the television 10 identify a second volume level corresponding to the second volume control signal. As shown in table I, when the second volume control signal is received, the second volume level “0” is identified. Referring to FIG. 5c, the OSD 500 includes a third volume field 506 with the volume level identified as “0”.

At step S412, the television 10 outputs the audio signals at the second volume level. In one implementation, the audio signals are completely muted.

It should be noted that the various steps in the method 400 illustrated in FIG. 4 may be performed in the order presented, or may be performed in a different order. Furthermore, in some embodiments, additional steps may be added and some steps can be canceled from the method 400. For example, the method 400 may further include a step of receiving a third volume control signal after the audio signals are completely muted. The third volume control signal is to change the audio signals back to the normal volume level. As shown in table I, when the third volume control signal is received, the television 10 outputs the audio signals at the volume level of “50”.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A television capable of outputting audio signals converted from television programs at a normal volume level, and capable of being controlled by a remote control, the remote control being provided with a mute key, the television comprising:
a memory;
a processor; and
a volume adjusting application stored in the memory and configured for execution by the processor, the volume adjusting application comprising instructions to:
receive a background volume control signal generated by a single operation with respect to the mute key provided on the remote control; and
output the audio signals converted from the television programs at a background volume level in response to the background volume control signal, whereby the audio signals are quickly adjusted from the normal volume level to the background volume level by the single operation with respect to the mute key, and the audio signals are outputted as a background for facilitating users to listen to other audio signals.

2. The television according to claim 1, wherein the volume adjusting application further comprises instructions to:
receive a mute control signal following the background volume control signal, the mute control signal is generated by further operating the mute key provided on the remote control; and
completely mute the audio signals converted from the television programs in response to the mute control signal.

3. The television according to claim 1, wherein the volume adjusting application further comprises instructions to:
receive a normal volume control signal following the mute control signal, the normal volume control signal is generated by further operating the mute key provided on the remote control; and
output the audio signals converted from the television programs at the normal volume level in response to the normal volume control signal.

4. A television capable of showing television programs, and capable of being controlled by a remote control, the remote control being provided with a mute key, the television comprising:
a memory;
a processor; and
a volume adjusting application stored in the memory and configured for execution by the processor, the volume adjusting application comprising instructions to:
receive a first volume control signal generated by operating the mute key provided on the remote control;
identify a first volume level to be applied to audio signals converted from the television programs corresponding to the first volume control signal;
output audio signals converted from the television programs at the first volume level in response to the first volume control signal;
receive a second volume control signal generated by operating the mute key provided on the remote control;
identify a second volume level to be applied to the audio signals converted from the television programs corresponding to the second volume control signal; and
output the audio signals converted from the television programs at the second volume level in response to the second volume control signal.

5. The television according to claim 4, wherein the action of output the audio signals converted from the television programs at the second volume level in response to the second volume control signal comprises:
completely mute the audio signals converted from the television programs in response to the second volume control signal.

6. The television according to claim 4, wherein the volume adjusting application further comprises instructions to:
receive a normal volume control signal following the second volume control signal, the normal volume control signal is generated by further operating the mute key provided on the remote control; and
output the audio signals converted from the television programs at a normal volume level in response to the normal volume control signal.

7. A method for adjusting a volume of audio signals, the method comprising:
receiving a first volume control signal;
identifying a first volume level to be applied to the audio signals corresponding to the first volume control signal;
outputting the audio signals at the first volume level in response to the first volume control signal;
receiving a second volume control signal;
identifying a second volume level to be applied to the audio signals corresponding to the second volume control signal; and
outputting the audio signals at the second volume level in response to the second volume control signal.

8. The method according to claim 7, wherein the action of outputting the audio signals at the second volume level in response to the second volume control signal comprises:
completely muting the audio signals in response to the second volume control signal.

9. The method according to claim 7, further comprising:
receiving a normal volume control signal following the second volume control signal;
identifying a normal volume level to be applied to the audio signals corresponding to the normal volume control signal; and
outputting the audio signals at the normal volume level in response to the normal volume control signal.
